(19) United States
(12) Patent Application Publication
(10) Pub. No.: US 2025/0384262 A1
(43) Pub. Date: Dec. 18, 2025

(54) ADAPTER NEURAL NETWORKS FOR DIGITAL CONTENT ITEMS

(71) Applicant: Google LLC, Mountain View, CA (US)

(72) Inventors: Vikram Aggarwal, Palo Alto, CA (US); Li Yang, Mountain View, CA (US)

(21) Appl. No.: 18/741,710

(22) Filed: Jun. 12, 2024

(51) Int. Cl. G06N 3/08; G06N 3/045

(52) U.S. Cl. CPC G06N 3/08; G06N 3/045

(57) ABSTRACT

Methods, systems, and apparatus, including computer programs encoded on a computer storage medium, for generating predictions regarding digital content items using an adapter neural network to generate content embeddings for the digital content items. In one aspect, a method comprises: receiving an input query that includes data characterizing a first digital content item; processing the data characterizing the first digital content item to generate a content embedding that represents the first digital content item that has been trained to optimize an accuracy of user access predictions generated by a sequence processing neural network for pairs of digital content items; generating an input sequence based on the input query that includes the content embedding; and generating a response to the input query by processing the input sequence using the sequence processing neural network.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that can generate predictions regarding digital content items by using an adapter neural network to generate content embeddings for the digital content items. In particular, the adapter neural network can be trained to generate content embeddings that, when processed by a sequence processing neural network (e.g., a language model), optimize a prediction accuracy of the sequence processing neural network.

According to a first aspect there is provided a method that includes: receiving an input query that includes data characterizing a first digital content item; processing the data characterizing the first digital content item to generate a content embedding that represents the first digital content item that has been trained to optimize an accuracy of user access predictions generated by a sequence processing neural network for pairs of digital content items; generating an input sequence based on the input query that includes the content embedding; and generating a response to the input query by processing the input sequence using the sequence processing neural network.

Particular embodiments of the subject matter described in this specification can be implemented so as to realize one or more of the following advantages.

A vast amount of digital content is created every day. Current neural network architectures, such as large language models, have a capability to perform processing tasks such as summarizing, describing, and recommending digital content. However, consistently retraining these powerful neural networks to usefully perform processing tasks for new digital content is impractical, due to the computational costs of training large machine learning models.

The described systems utilize a modular architecture, in which an adapter neural network is configured to generate content embeddings of digital content items and a sequence processing neural network (e.g., a pre-trained language model) is configured to perform processing tasks by processing the generated content embeddings. The described systems can utilize a fixed sequence processing neural network, while training the adapter neural network to generate content embeddings that, when provided as input to the sequence processing neural network, result in the sequence processing neural network generating accurate predictions for any of a variety of queries relating to a given content item.

The adapter neural network can be a relatively light-weight (e.g., compared to a full language model) neural network specialized to particular digital content items (e.g., specific media, media for a particular user or for a particular type of user, etc.). Once trained, the described systems can perform processing tasks for digital content items using fewer computational resources (e.g., processing time, power consumption, memory usage, etc.) compared to a dedicated language model that can attain a similar level of performance (e.g., prediction accuracy). For example, an implementation of the described systems can include a light-weight adapter neural network specialized for a particular user (e.g., deployed on a user device) that communicates with a large language model (e.g., deployed on a central server).

The adapter neural network can be trained using less training data and in fewer training iterations than a full language model. Additionally, the described systems can train the adapter neural network without retraining the sequence processing neural network. This can significantly reduce the computational cost of training the described systems. This also enables the described systems to be more easily retrained, e.g., based on newly created digital content.

The described systems can also utilize a contrastive loss to train the adapter neural network to generate content embeddings that are similar for content items that are accessed together (e.g., videos that are often watched by the same users) and that are dissimilar for content items that are not accessed together. Because the contrastive loss only depends on content embeddings generated by the adapter neural network, the described systems can use the contrastive loss to pre-train the adapter neural network without requiring the sequence processing neural network. By pre-training the adapter neural network using the contrastive loss, the described systems can therefore more efficiently train the adapter neural network to generate useful content embeddings.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example digital content prediction system that includes an adapter neural network for digital content items.

FIG. 2 is a flow diagram of an example process for generating predictions for digital content items.

FIG. 3 is a block diagram illustrating training an example adapter neural network to generate content embeddings for digital content items.

FIG. 4 is a block diagram illustrating training an example adapter neural network using training data for co-access predictions for digital content items.

FIG. 5 is a flow diagram of an example process for training an example adapter neural network to generate content embeddings for producing predictions for digital content items.

FIG. 6 is a flow diagram of an example process for updating an example adapter neural network based on a contrastive loss between pairs of content embeddings.

FIG. 7 is a flow diagram of an example process for updating an example adapter neural network based on a predictive loss for predictions generated using the adapter neural network.

Like reference numbers and designations in the various drawings indicate like elements.

### DETAILED DESCRIPTION

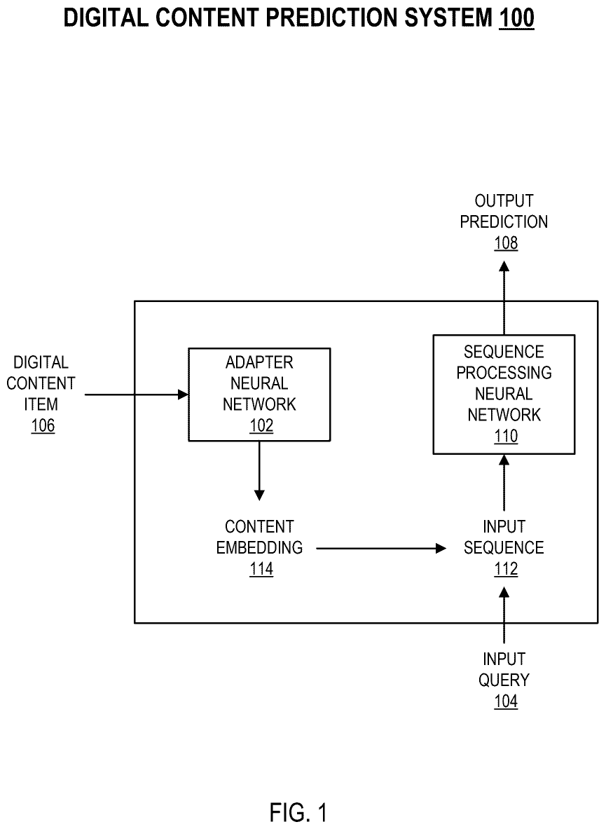

FIG. 1 shows an example digital content prediction system 100 that includes an adapter neural network 102 for digital content items. The digital content prediction system 100 is an example of a system implemented as computer programs on one or more computers in one or more locations in which the systems, components, and techniques described below are implemented.

The digital content prediction system 100 is configured to process an input query 104 regarding one or more digital content items 106 and generate an output prediction 108 for the digital content item 106 in response to the query 104.

The digital content item 106 can be any of a variety of digital media. As an example, the digital content item 106 can be video media or a collection of video media, such as a movie, a television show, a streamed video, and so on. As another example, the digital content item 106 can be audio media or a collection of audio media, such as a song, an album, a podcast, and so on. As another example, the digital content item 106 can be text media, such as a digital book, an article, a webpage, and so on. As another example, the digital content item 106 can be a product on a digital store front.

The input query 104 can be any of a variety of queries regarding the digital content item 106. As one example, the input query 104 can include a request to describe the digital content item 106 (e.g., to describe a genre or category for a piece of video, audio, or text media, to summarize a piece of video, audio, or text media, to describe a product category for a product on a digital store front, etc.), and the output prediction 108 can include the requested description of the digital content item 106. As another example, the input query 104 can include a request to classify a user (e.g., into one of a plurality of user categories based on, e.g., predicted user interests, such as preferred content genres, preferred content creators, etc.) based on a collection of digital content items 106 associated with the user (e.g., based on a viewing, listening, or reading history of the user, based on a purchase history of the user, etc.), and the corresponding output prediction 108 can include the requested classification of the user.

The input query 104 can be a query regarding predicted user access to the digital content item 106. As an example, the input query can include a request to predict whether a user will access the digital content item 106 at some future time. As another example, the input query can include a request to predict whether a user will access the digital content item 106 if the digital content item 106 is presented to the user.

User access to the digital content item 106 can include, e.g., instances of a user accessing the digital content item 106, acquiring the digital content item 106, interacting with the digital content item 106, and so on. As an example, a user can access a digital content item 106 by streaming the digital content item 106, downloading the digital content item 106, visiting a web page for the digital content item 106, and so on. As another example, when the digital content item 106 is a product on a digital store front, a user can access the digital content item 106 by viewing, purchasing, wishlisting, etc., the digital content item 106 on the digital store front.

For example, the input query 104 can include a request to predict user access to a digital content item 106, and the output prediction 108 can include the requested prediction of user access to the digital content item 106 by an average user (e.g., a prediction of average user access for a plurality of users, such as a plurality of users from training data for the system 100). As another example, the input query 104 can include data characterizing a particular user and can include a request to predict user access to the digital content item 106, and the output prediction 108 can include the requested prediction of user access to the digital content item 106 by the particular user.

The input query 104 can be a query regarding co-access predictions for multiple digital content items 106. A co-access prediction for the digital content item 106 can characterize a prediction of whether a user will access the digital content item 106 based on whether the user has accessed other digital content items (e.g., other digital content items similar to the digital content item 106). As an example, the input query 104 can include a request to predict user access to the digital content item 106 for a user given that the user has already accessed another set of one or more digital content items (e.g., based on a viewing, listening, or reading history of the user, based on a purchase history of the user, etc.), and a corresponding output prediction 108 can include the requested co-access prediction for the user. The input query 104 can include a request to perform a co-access prediction for an average user (e.g., an average co-access prediction for a plurality of users, such as a plurality of users from training data for the system 100). The input query 104 can also include data characterizing a particular user alongside a request to perform a co-access prediction, and the output prediction 108 can include the requested co-access prediction for the particular user.

The digital content prediction system 100 includes a sequence processing neural network 110 that can process an input sequence 112 to generate the output prediction 108. The input sequence 112 can be a token sequence representing a request to generate the output prediction 108 and can include tokens representing the input query 104 for the prediction and tokens representing data characterizing the digital content item 106 for the predictions.

The output prediction 108 can similarly be a token sequence representing a response to the input query 104. Each of the tokens within the token sequences of the input sequence 112 and the output prediction 108 can be a vector embedding identifying data associated with the token (e.g., a symbol, a word, a sequence of text, etc., represented by the token). In some implementations, the input sequence 112, the output prediction 108, or both can include tokens representing non-text data (e.g., image data, audio data, video data, etc.). The sequence processing neural network 110 can include a token vocabulary that specifies a respective vector embedding and associated data for each of a pre-defined set of tokens for the token vocabulary. When the sequence processing neural network 110 generates the output prediction 108, the sequence processing neural network 110 can select the tokens of the token sequence for the output prediction 108 from the token vocabulary of the sequence processing neural network 110.

The sequence processing neural network 110 can have any appropriate architecture for processing the input sequences 112 to generate the output predictions 108. For example, the sequence processing neural network 110 can be an auto-regressive generative model (e.g., a Transformer, a recurrent neural network, etc.) that can auto-regressively generate the sequences of tokens for output predictions 108 by processing the sequences of tokens for corresponding input sequences 112. The sequence processing neural network 110 can, for example, be a large language model (LLM) that can auto-regressively generate tokenized representations of text data. The sequence processing neural network 110 can be trained (e.g., pre-trained) to perform one or more machine learning tasks. For example, the sequence processing neural network 110 can be an LLM trained to perform one or more language processing tasks.

The adapter neural network 102 is configured to process data characterizing the digital content item 106 to generate a content embedding 114 for the digital content item 106. As part of generating the content embedding 114, the digital content prediction system 100 can identify the digital content item 106 specified by the input query 104 and retrieve the data characterizing the digital content item 106 (e.g., from an external database, from a storage device, etc.). The system 100 can then use the adapter neural network 102 to process the retrieved data characterizing the digital content item 106 to generate the content embedding 114.

The data characterizing the digital content item 106 can generally include any appropriate data that identifies the content item 106, specifies properties of the content item 106, or both. For example, the data can include any one or more of a genre, a title, a text description, a summary of contents, an author, an artist, a length, a size, a price, meta-data, etc., of the digital content item 106.

The data characterizing the digital content item 106 can have any of a variety of data formats. As an example, the data characterizing the digital content item 106 can be structured numerical data that includes fields for pre-determined attributes of the digital content item 106. As another example, the data characterizing the digital content item 106 can be a tokenized representation (e.g., a sequence of tokens) of the digital content item 106.

The content embedding 114 for the digital content item 106 can be a sequence of one or more tokens that can be included within input token sequences (e.g., input sequences 112) processed by the sequence processing neural network 110. For example, the content embedding 114 for the digital content item 106 can be a sequence of tokens with a pre-determined length. The adapter neural network 110 can generate the content embedding 114 by determining a respective vector embedding (e.g., from a same vector embedding space as the tokens representing the input sequence 112 and the output prediction 108) specified by each of the tokens for the content embedding 114. When the sequence processing neural network 110 includes a token vocabulary, the adapter neural network 110 can generate the content embedding 114 to include tokens that are not present within the token vocabulary of the sequence processing neural network 110.

When the input query 104 is a query regarding multiple digital content items 106, the adapter neural network 102 can process data characterizing each of the multiple digital content items 106 to generate a corresponding content embedding 114. In some implementations, the adapter neural network 102 can generate the content embeddings 114 for multiple digital content items 106 dependent on one another. For example, the adapter neural network 102 can generate the content embeddings 114 for multiple digital content items 106 by applying using one or more self-attention operations to the data characterizing the multiple digital content items 106.

The adapter neural network 110 can have any appropriate architecture for processing the data characterizing the digital content item 106 to generate the content embedding 114 for the digital content item 106. For example, the adapter neural network 102 can be a Transformer configured to process sequences of tokens representing the digital content item 106 to generate the content embedding 114. When the data representing the digital content item 106 is a sequence of tokens, the adapter neural network 102 can process the data representing the digital content item 106 using a variety of attention mechanisms, such as self-attention, cross-attention with machine learned sets of tokens, and so on. For example, the adapter neural network 102 can have a Perceiver architecture, as described by Jaegle et al. in “Perceiver: General Perception with Iterative Attention”.

In some implementations, the adapter neural network 102 can include a content encoder network configured to process the data characterizing digital content item 106 (e.g., structured numerical data representing the digital content item 106) to generate a corresponding encoded representation (e.g., a tokenized representation) of the digital content item 106. The adapter neural network 102 can include one or more cross-attention layers configured to process the encoded representation of the digital content item 106 and a plurality of machine learned query vectors following cross-attention operations to generate the content embedding 114. For example, the adapter neural network 102 can have a Q-Former architecture, as described by Li et al. in “BLIP-2: Bootstrapping Language-Image Pre-training with Frozen Image Encoders and Large Language Models”.

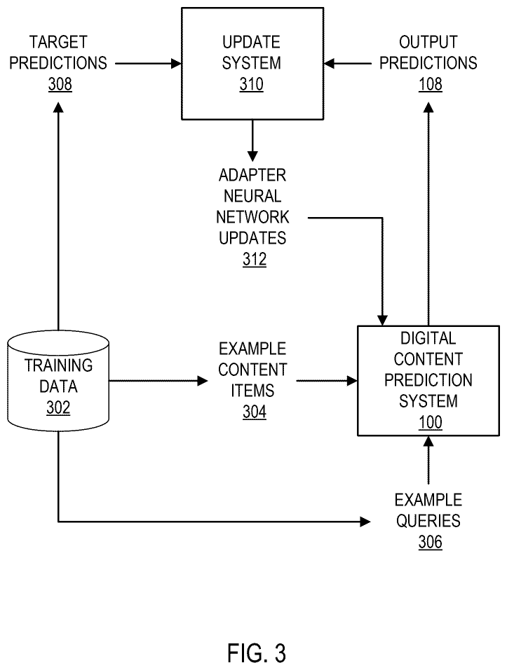

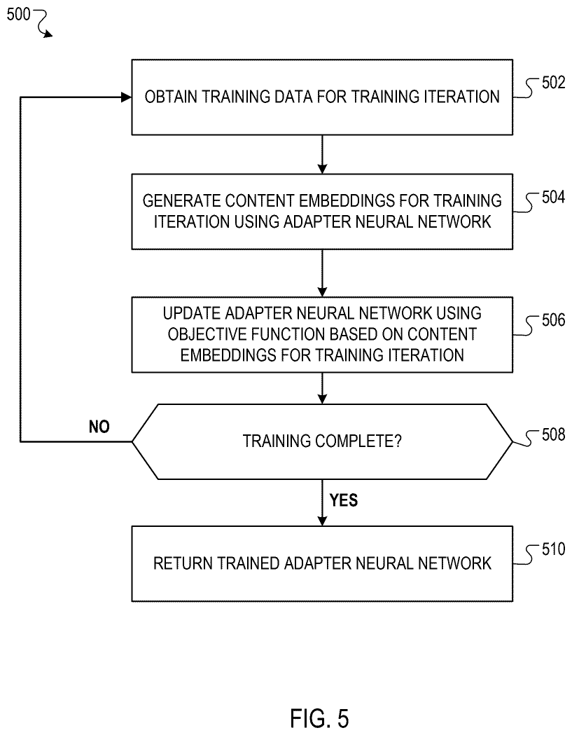

Training the adapter neural network 102 to produce content embeddings 114 for digital content items 106 is described in more detail below with reference to FIG. 3 and FIG. 5.

The system 100 can generate the input sequence 112 by combining the content embedding 114 and the input query 104. For example, the system 100 can generate a formatted token sequence based on the input query 104 and can generate the input sequence 112 by inserting generated tokens from the content embedding 114 as tokens within the formatted token sequence.

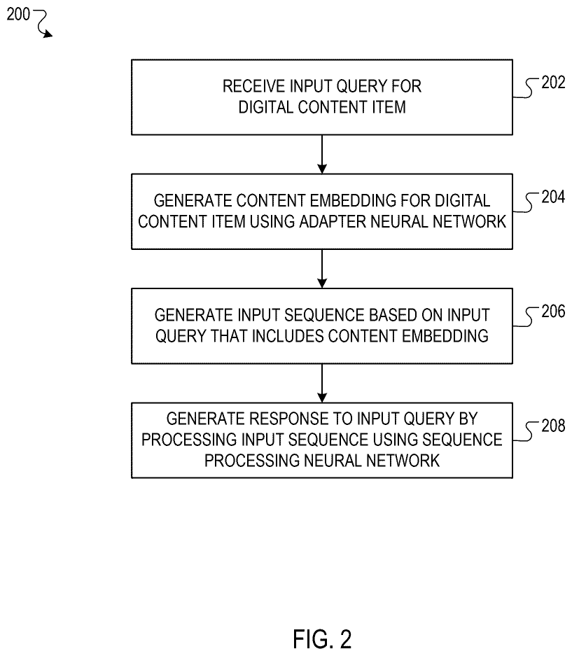

An example process for generating predictions for digital content items using the digital content prediction system 100 is described in more detail below with reference to FIG. 2.

After generating the output prediction 108 for the digital content item 106, the digital content prediction system 100 can return the output prediction 108, e.g., to a user or an external system. As one example, the input query 104 can be a request from a user to describe the digital content item 106, and the system 100 can return the output prediction 108 including the requested description to the user. As another example, the input query 104 can be a request from a user to provide a recommendation regarding the digital content item 106 (e.g., based on the user's interests), and the system 100 can return the output prediction 108 including the requested recommendation to the user. As another example, the input query 104 can be a request from an external recommendation system to generate an access prediction regarding the digital content item 106 for a user, and the system 100 can return the output prediction 108 to the external recommendation system.

FIG. 2 is a flow diagram of an example process 200 for generating predictions for digital content items. For convenience, the process 200 will be described as being performed by a system of one or more computers located in one or more locations. For example, a digital content prediction system, e.g., the digital content prediction system 100 of FIG. 1, appropriately programmed in accordance with this specification, can perform the process 200.

The system receives a query regarding a digital content item (202). The query can include data representing the digital content item (e.g., data that specifies the digital content item).

As an example, the query can characterize a request to describe the digital content item.

As another example, the query can characterize a request to perform a co-access prediction for the digital content item. For example, the query can include data characterizing one or more additional items and can characterize a request to predict whether a user will access the digital content item based on the user having accessed the one or more additional digital content items.

As a further example, the input query can include data characterizing a particular user and can characterize a request to predict whether the particular user will access the digital content item based on the particular user having accessed the one or more additional digital content items.

The digital content item can be any of a variety of digital media. As an example, the digital content item can be video media or a collection of video media, such as a movie, television show, streamed video, and so on. As another example, the digital content item can be audio media or a collection of audio media, such as a song, album, podcast, and so on. As another example, the digital content item can be text media, such as a digital book, article, webpage, and so on. As another example, the digital content item can be a product on a digital store front.

User access to the digital content item can include, e.g., an instance of a user accessing the digital content item, acquiring the digital content item, interacting with the digital content item, and so on. As an example, a user can access the digital content item by streaming the digital content item, downloading the digital content item, visiting a web page for the digital content item, and so on. As another example, when the digital content item is a product on a digital store front, a user can access the digital content item by viewing, purchasing, wishlisting, etc., the digital content item on the digital store front.

The system generates a content item embedding that represents the digital content item using an adapter neural network based on data characterizing the digital content item (204). The system can obtain the data characterizing the digital content item from any of a variety of sources. As one example, the system can identify the digital content item based on the received query and can retrieve the data characterizing the digital content item, e.g., from an external database storing the data characterizing the digital content item, from a memory of the system, and so on. As another example, the received query can include the data characterizing the data characterizing the digital content item.

The data characterizing the digital content item can have any of a variety of data formats. As an example, the data characterizing the digital content item can be structured numerical data that includes fields for pre-determined attributes of the digital content item. As another example, the data characterizing the digital content item can be a tokenized representation (e.g., a sequence of tokens) of the digital content item. The content item embedding for the digital content item can be a sequence of one or more tokens. For example, the content item embedding for the digital content item can be a sequence of tokens with a pre-determined length. As described above, the content item embedding can be a sequence of one or more tokens that can be included within input token sequences (e.g., input sequences) processed by a sequence processing neural network.

The adapter neural network can have any appropriate architecture for processing the data characterizing the digital content item to generate the content item embedding for the digital content item. For example, the adapter neural network can be a Transformer configured to process sequences of tokens representing the digital content item to generate the content item embedding. When the data representing the digital content item is a sequence of tokens, the adapter neural network can process the data representing the digital content item using a variety of attention mechanisms, such as self-attention, cross-attention with machine learned sets of tokens, and so on. For example, the adapter neural network can have a Perceiver architecture, as described by Jaegle et al. in “Perceiver: General Perception with Iterative Attention”.

In some implementations, the adapter neural network can include a content encoder network configured to process the data characterizing digital content item (e.g., structured numerical data representing the digital content item) to generate a corresponding encoded representation (e.g., a tokenized representation) of the digital content item. The adapter neural network can include one or more cross-attention layers configured to process the encoded representation of the digital content item and a plurality of machine learned query vectors following cross-attention operations to generate the content embedding. For example, the adapter neural network can have a Q-Former architecture, as described by Li et al. in “BLIP-2: Bootstrapping Language-Image Pre-training with Frozen Image Encoders and Large Language Models”.

The adapter neural network can be trained to generate content item embeddings that, when processed by the sequence processing neural network, optimize an accuracy of predictions generated by the sequence processing neural network. Training the adapter neural network is described in more detail below with reference to FIG. 3 and FIG. 5.

The sequence processing neural network can be configured to process input sequences (e.g., input token sequences) to generate the output predictions (e.g., output token sequences). For example, the sequence processing neural network can be, e.g., a language model that has been trained (e.g., pre-trained) to perform one or more language processing tasks.

The system can generate an input sequence based on the received query that includes the content item embedding for the digital content item (206). The system can generate the input sequence by combining the content item embedding for the digital content item and the query. For example, the system can generate a formatted token sequence based on the input query and can generate the input sequence by inserting the content item embedding for the digital content item as tokens within the formatted token sequences.

For example, when a received query is a request to describe a particular video A, the formatted token sequence can represent the prompt “Describe this video: ”. The system can insert content embedding for the video A (e.g., here represented by the notation “<video A>”) within the formatted token sequence to generate the input sequence representing the prompt “Describe this video: <video A>”.

The system can then generate a response to the received query by processing the input sequence using a sequence processing neural network (208). For example, when the query characterizes a request to describe the digital content item, the response to the input query can include one or more predicted attributes of the digital content item. As another example, when the query characterizes a request to predict whether a user will access the digital content item based on the user having accessed one or more additional digital content items, the response to the input query can characterize a prediction of whether the user will access the digital content item based on the user having accessed the one or more additional digital content items. As a further example, when the query characterizes a request to predict whether a particular user will access the digital content item based on the user having accessed one or more additional digital content items, the response to the input query can characterize a prediction of whether the particular user will access the digital content item based on the user having accessed the one or more additional digital content items.

FIG. 3 illustrates training a digital content prediction system 100 using an update system 310.

The update system 310 can train the digital content prediction system 100 using training data 302 for generating output predictions 108 regarding example digital content items 304.

The training data can include a plurality of training examples, with each training example including an example query 306 regarding example digital content items 304 for the training example, data characterizing the example digital content items 304 for the training example, and target predictions 308 for the training example (e.g., target predictions 308 representing a correct response to the example query 306 for the training example).

The update system 310 can train the digital content prediction system 100 to reduce an error between the output predictions 108 generated by the digital content prediction system 100 and corresponding target predictions 308 from the training data 302.

As described above with reference to FIG. 1, the digital content prediction system 100 can include an adapter neural network and a sequence processing neural network. The sequence processing neural network can be configured to process input sequences (e.g., input token sequences) to generate the output predictions 108 (e.g., output token sequences). For example, the sequence processing neural network can be, e.g., a language model that has been trained (e.g., pre-trained) to perform one or more language processing tasks. The adapter neural network can be configured to process data characterizing the example digital content items 304 to generate content embeddings for the example digital content items 304 that can be included within input sequences and processed by the sequence processing neural network.

During training, the adapter neural network can process data characterizing the example digital content items 304 to generate content embeddings for the example digital content items 304. The sequence processing neural network can process input sequences determined based on the example queries 306 and the generated content embeddings for the example digital content items 304 to generate the output predictions 108.

The sequence processing neural network can already be trained to perform one or more processing tasks prior to training the digital prediction system 100. For example, the sequence processing neural network can be a language model that has been trained to perform one or more language processing tasks. The sequence processing neural network can be trained to perform the one or more processing tasks using any appropriate machine learning techniques, such as using unsupervised learning, supervised fine tuning, reinforcement learning with human feedback, instruction tuning, and so on.

As part of training the digital content prediction system 100, the update system 310 can train the adapter neural network while holding the trained sequence processing neural network fixed. For example, the update system 310 can determine adapter neural network updates 312 for training the digital content prediction system 100 without updating the sequence processing neural network. In particular, the update system 310 can generate the adapter neural network updates 312 using any appropriate machine learning technique to optimize an objective function that encourages the digital content prediction system 100 to generate output predictions 108 that agree with corresponding target predictions 306 from the training data. An example process for training the adapter neural network is described in more detail below with reference to FIG. 5.

The example queries 306 can include requests for the digital content prediction system 100 to generate any of a variety of predictions regarding the example digital content items 304. For example, one or more of the example queries 306 can include requests to describe corresponding example digital content items 304 (e.g., to describe a genre or category for a piece of video, audio, or text media, to summarize a piece of video, audio, or text media, to describe a product category for a product on a digital store front, etc.), and the corresponding target predictions 308 can include the correct descriptions for the corresponding example digital content items 304. As another example, one or more of the example queries 306 can include requests to classify users (e.g., into one of a plurality of user categories based on, e.g., predicted user interests, such as preferred content genres, preferred content creators, etc.) based on corresponding example digital content items 304 associated with the users (e.g., based on viewing, listening, or reading histories of the users, based on purchase histories of the users, etc.), and the corresponding target predictions 308 can include correct classifications of the users.

The example queries 306 can include queries regarding predicted user access to corresponding example digital content items 304. As an example, one or more of the example queries 306 can include requests to predict whether users will access the corresponding example digital content items 304 at some future time. As another example, t one or more of the example queries 306 can include requests to predict whether users will access the corresponding example digital content items 304 if the example digital content items 304 are presented to the users.

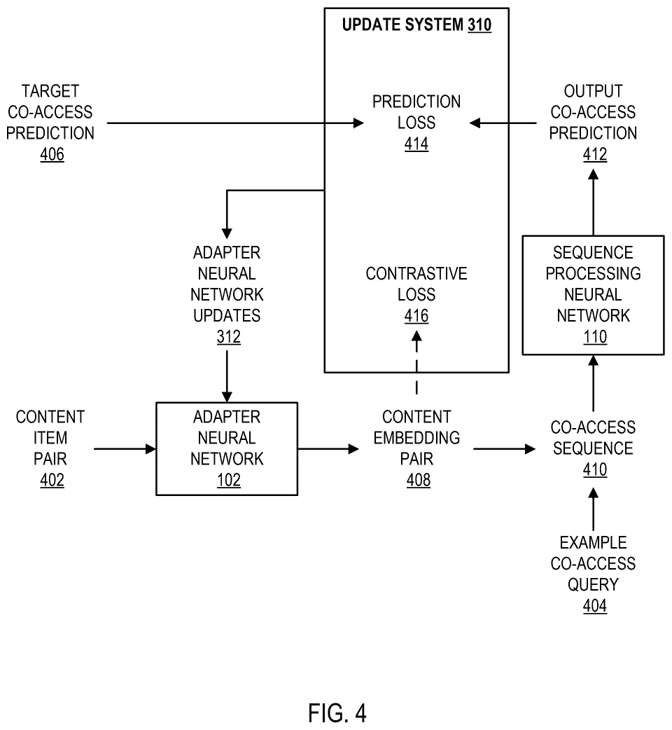

The example queries 306 can include queries regarding co-access predictions for multiple digital content items 304 (e.g., queries regarding co-access predictions for pairs of example digital content items 304). Training the adapter neural network using training data 302 for co-access predictions for digital content items is described in more detail below with reference to FIG. 4.

FIG. 4 illustrates an update system 310 training an example adapter neural network 102 using training data for example co-access predictions for digital content item pairs 402.

As described above, the training data can include training examples for a variety of predictions and the update system 310 can optimize an objective function that measures a loss for the predictions. When the training data includes training examples for co-access predictions, the update system 310 can train the adapter neural network 102 to optimize an objective function that measures a loss for the co-access predictions.

Each of the co-access prediction training examples can include an example co-access query 404 regarding a digital content item pair 402 for the training example, data characterizing each of the digital content item pair 402 for the training example, and target co-access predictions 406 for the training example (e.g., target co-access predictions 406 representing a correct response to the example co-access query 404 for the training example).

As described in more detail below with reference to FIG. 5, the update system 310 can train the adapter neural network 102 over a sequence of training iterations. At each training iteration, the update system 310 can train the adapter neural network 102 using co-access prediction training examples for the training iteration.

For each of the co-access prediction training examples, the adapter neural network 102 can process the data characterizing the digital content item pair 402 for the training example to generate a corresponding pair 408 of content item embeddings for the training example.

At one or more training iterations, the update system 310 can evaluate a contrastive loss 416 between the content item embedding pairs 408 generated by the adapter neural network 102 for the training iterations. As an example, the contrastive loss 416 can be an InfoNCE loss, as described by van den Oord et al. in “Representation Learning with Contrastive Predictive Coding”. In particular, the contrastive loss 416 can be determined using content embedding pairs 408 that have been accessed by the same user as positive examples for the contrastive loss and using content embedding pairs 408 that have not been accessed by the same user as negative examples for the contrastive loss.

At one or more training iterations, the sequence processing neural network 110 can process an input co-access sequence 410, generated by combining the content item embedding pair 408 and the example co-access query 404 for the training example, to generate an output co-access prediction 412 for the training example.

When the sequence processing neural network 110 generates output co-access predictions, the update system 300 can evaluate a prediction loss between the output co-access predictions 412 generated by the sequence processing neural network 110 and corresponding target co-access predictions 406 from the training data. For example, the prediction loss 414 can be a negative log-likelihood of the target co-access predictions 406 as determined by the sequence processing neural network 110 processing the input co-access input sequence 410.

As described in more detail below with reference to FIG. 5, at each training iteration, the update system 310 can generate adapter neural network updates 312 to train the adapter neural network 102 based on the co-prediction losses for the training iteration. The update system 310 can evaluate different co-prediction losses at different training iterations. For example, the update system 310 can pre-train the adapter neural network 102 during a first set of training iterations by updating the adapter neural network 102 based on the contrastive loss. After pre-training the adapter neural network 102, system 310 can train (e.g., fine-tune) the adapter neural network 102 during a second set of training iterations by updating the adapter neural network 102 based on the predictive loss 414 alone or a combination of the predictive loss 414 and the contrastive loss 416.

FIG. 5 is a flow diagram of an example process for training an adapter neural network to generate content embeddings for producing predictions for digital content items. For convenience, the process 500 will be described as being performed by a system of one or more computers located in one or more locations. For example, a digital content prediction system, e.g., the digital content prediction system 100 of FIG. 1, appropriately programmed in accordance with this specification, can perform the process 500.

The system can train the adapter neural network over a sequence of training iterations.

At each training iteration, the system can obtain training data for the training iteration (502). The training data for the training iteration can include a plurality of training examples for the training iteration. Each training example includes data characterizing one or more digital content items for the training example. In some implementations, each training example can include data characterizing an example query and a target prediction (e.g., a target label) for the training example.

The example queries can be any of a variety of queries regarding the digital content items for the training examples. As an example, the input query for a training example can include a request to describe the digital content items for the training example, and the target prediction can include a description of the digital content items. As another example the input query for a training example can include a request to classify a user based on the digital content items for the training example, and the target prediction for the training example can include the requested classification of the user.

The example queries can include queries regarding predicted user access to the digital content items of the training examples. For example, the input query for a training example can include a request to predict user access to the digital content items of the training example, and the target prediction for the training example can include the requested prediction of user access to the digital content items of the training example by an average user (e.g., a prediction of average user access for a plurality of users, such as a plurality of users from the training data). As another example, the input query for a training example can include data characterizing a particular user and can include a request to predict user access to the digital content items of the training example, and the target prediction for the training example can include the requested prediction of user access to the digital content items for the training example by the particular user. As another example, the input query for a training example can include a request to generate a co-access prediction regarding the digital content items of the training example, and the target prediction for the training example can include the requested co-access prediction of for the digital content items of the training example.

For each of the training examples of the training iteration, the system can generate content item embeddings for the training example using the adapter neural network (504). In particular, the system can generate content item embeddings for the digital content items of the training example following step 204 of the process 200 described above with reference to FIG. 2.

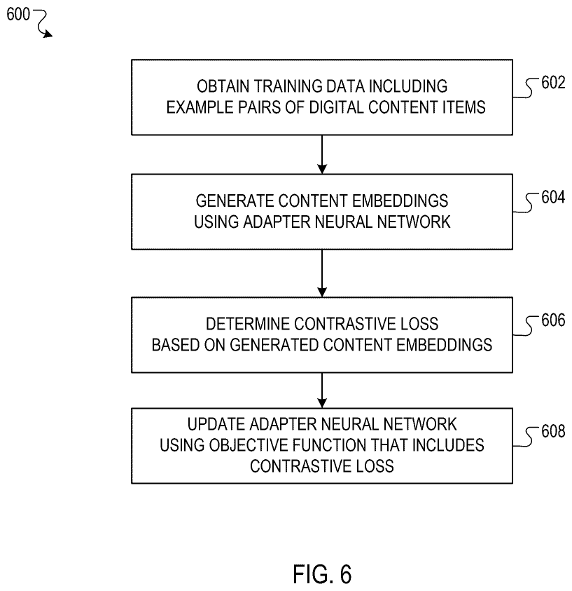

The system can then update the adapter neural network using an objective function that depends on the content item embeddings for the training examples for the training iteration (506). The system can update the adapter neural network using different objective functions for different training iterations. For example, during a first set of training iterations, the training examples for the iteration can include pairs of example digital content items and the system can pre-train the adapter neural network by updating the adapter neural network using an objective function that measures a contrastive loss for corresponding pairs of content embeddings. An example process for updating the adapter neural network based on a contrastive loss between pairs of content embeddings is described in more detail below with reference to FIG. 6.

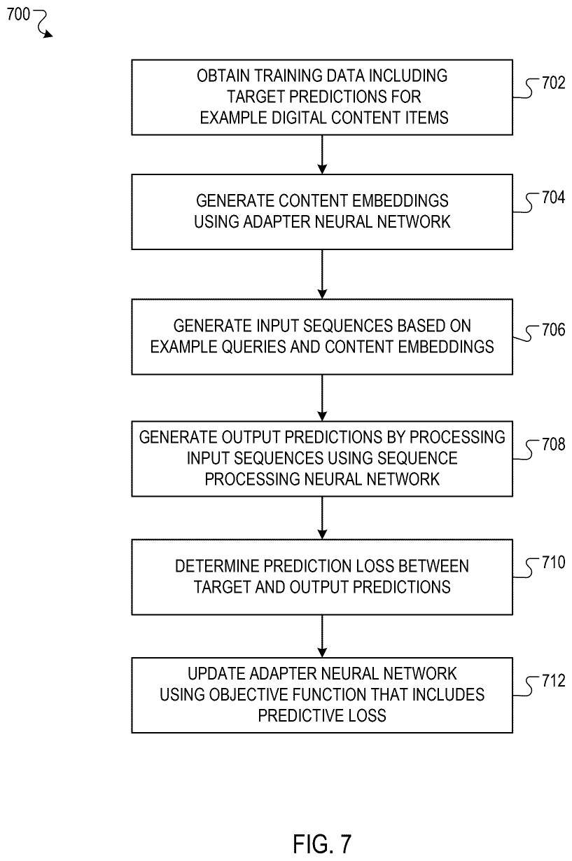

As another example, during a second set of training iterations (e.g., after pre-training the adapter neural network), the system can train (e.g., fine-tune) the adapter neural network by updating the adapter neural network based on an objective function that measures a predictive loss for predictions generated using the content embeddings from the adapter neural network. In particular, when the training examples include data characterizing example queries and target predictions for the training examples, the system can generate output predictions based on the content item embeddings for the training examples as responses to the example queries using a sequence processing neural network (e.g., following steps 206 and 208 of the process 200 described above with reference to FIG. 2). The objective function that measures the predictive loss can measure a difference between the output predictions and the target predictions for the training examples, and the system can update the adapter neural network to increase an accuracy of predictions generated by the sequence processing neural network. An example process for updating the adapter neural network based on a predictive loss for predictions generated using content embeddings from the adapter neural network is described in more detail below with reference to FIG. 7.

In some implementations, during some training iterations, the system can update the adapter neural network using an objective function that measures both a contrastive loss and a predictive loss for the training examples for the training iteration.

At each training iteration, the system can determine whether the training is complete (508). As an example, the system can determine that training is complete after a pre-determined number of training iterations. As another example, the system can determine that training is complete when a value of the objective function for the training iteration falls below a pre-defined threshold. As another example, the system can determine that training is complete when a difference between values of the objective function for the current training iteration and a previous training iteration falls below a pre-defined threshold.

If the system determines that the training is not complete, the system can continue to a next training iteration (e.g., return to step 502).

When the system determines that the training is complete, the system can return the trained adapter neural network (510).

FIG. 6 is a flow diagram of an example process for updating an example adapter neural network based on a contrastive loss between pairs of content embeddings. For convenience, the process 600 will be described as being performed by a system of one or more computers located in one or more locations. For example, a digital content prediction system, e.g., the digital content prediction system 100 of FIG. 1, appropriately programmed in accordance with this specification, can perform the process 600.

The system can obtain training data that includes example pairs of digital content items (602).

For each example pair of digital content items, the system can generate a corresponding pair of content item embedding pair using the adapter neural network (604). In particular, the system can generate the content item embedding pairs for the training examples following step 204 of the process 200 described above with reference to FIG. 2.

The system can determine a contrastive loss based on the pairs of content item

embeddings generated by the adapter neural network (606). For example, as described above, the contrastive loss can be an InfoNCE loss determined between the pairs of content item embeddings generated by the adapter neural network.

The system can finally update the adapter neural network using an objective function that includes the contrastive loss (608). By including the contrastive loss, the objective function for the training iteration can encourage the adapter neural network to generate (i) more similar pairs of content embeddings for pairs of digital content items that are more likely to both be accessed by a user and (ii) more dissimilar pairs of content embeddings for pairs of digital content items that are less likely to both be accessed by a user.

FIG. 7 is a flow diagram of an example process for updating an example adapter neural network based on a predictive loss for predictions generated using content embeddings from the adapter neural network. For convenience, the process 700 will be described as being performed by a system of one or more computers located in one or more locations. For example, a digital content prediction system, e.g., the digital content prediction system 100 of FIG. 1, appropriately programmed in accordance with this specification, can perform the process 700.

The system can obtain training data that includes target predictions (e.g., target labels) for example digital content items (702). In particular, the training data can include a plurality of training examples for the training iteration, with each training example. Each training example can include, data characterizing one or more digital content items for the training example, data characterizing an example query, a target prediction (e.g., a target label) for the training example.

The example queries can be any of a variety of queries regarding the digital content items for the training examples. As an example, the example query for a training example can include a request to describe the digital content items for the training example, and the target prediction can include a description of the digital content items (e.g., when an example digital content item is a video A, the corresponding example query can be “describe video A” or “summarize video A”). As another example, the example query for a training example can include a request to classify a user based on the digital content items for the training example, and the target prediction for the training example can include the requested classification of the user (e.g., when an example collection of digital content items is a purchase history of a user, the corresponding example query can be “classify the user based on the following purchase history . . . ”).

The example queries can include queries regarding predicted user access to the digital content items of the training examples. For example, the input query for a training example can include a request to predict user access to the digital content items of the training example (e.g., when an example digital content item is a song B, the corresponding example query can be “how likely is a user to listen to song B?”), and the target prediction for the training example can include the requested prediction of user access to the digital content items of the training example by an average user (e.g., a prediction of average user access for a plurality of users, such as a plurality of users from the training data). As another example, the input query for a training example can include data characterizing a particular user and can include a request to predict user access to the digital content items of the training example, and the target prediction for the training example can include the requested prediction of user access to the digital content items for the training example by the particular user. As another example, the input query for a training example can include a request to generate a co-access prediction regarding the digital content items of the training example (e.g., when an example pair of digital content items includes video C and video D, the corresponding example query can be “if a user has watched video C, how likely is the user to watch video D?”), and the target prediction for the training example can include the requested co-access prediction of for the digital content items of the training example.

For each example digital content item for the training examples, the system can generate a corresponding content item embedding using the adapter neural network (704). In particular, the system can generate the content item embeddings for the training examples following step 204 of the process 200 described above with reference to FIG. 2.

The system can generate input sequences based on example queries and the content item embeddings for the training examples (706). In particular, the system can generate the input sequences for the training examples following step 206 of the process 200 described above with reference to FIG. 2.

The system can generate output predictions by processing the input sequences using a sequence processing neural network (708). In particular, the system can generate the for the training examples following step 208 of the process 200 described above with reference to FIG. 2.

The system can then determine a prediction loss between the output predictions generated by the sequence processing neural network and corresponding target predictions from the training data (710). As an example, the target prediction for each training example can be a target sequence processing neural network output for the training example and the system can determine, for each training example, a probability assigned to the target sequence processing neural network output by the sequence processing neural network by processing the input sequence for the training example. The prediction loss can be determined based on the probabilities assigned to the target predictions for the training examples by the sequence processing neural network by processing the input sequences for the training examples.

The system can finally update the adapter neural network using an objective function for predictions that includes the predictive loss (712). In particular, the objective function can encourage the adapter neural network to increase an accuracy of user access predictions generated by the sequence processing neural network for the training examples, as measured by the predictive loss.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method comprising: receiving an input query that includes data representing a first digital content item; processing data characterizing the first digital content item using an adapter neural network to generate a content embedding that represents the first digital content item; generating an input sequence based on the input query that includes the content embedding; and generating a response to the input query by processing the input sequence using a sequence processing neural network; and wherein the adapter neural network has been trained to optimize an accuracy of user access predictions generated by the sequence processing neural network for pairs of digital content items.

Embodiment 2 is the method of embodiment 1, wherein training the adapter neural network to optimize an accuracy of user access predictions generated by the sequence processing neural network for pairs of digital content items comprises: updating the adapter neural network at each of one or more training iterations, comprising: obtaining training examples for the training iteration, wherein each training example includes data characterizing a pair of digital content items for the training example and includes a target label characterizing user access to both digital content items for the training example; processing, for each training example, the data characterizing the pair of digital content items to generate a corresponding pair of content embeddings for the training example; and updating the adapter model using an objective function for the training iteration, wherein the objective function for the training iteration is based on the pairs of content embeddings for the training examples of the training iteration.

Embodiment 3 is the method of embodiment 2, wherein, at each of a subset of the one or more of training iterations: the objective function for the training iteration measures, based on the target labels for the training examples, an accuracy of user access predictions generated by the sequence processing neural network for the training examples, wherein the user access prediction for a given training example characterizes a prediction that a user will access a first digital content item of the pair of digital content items for the given training example based on the user having accessed a second digital content item of the pair of digital content items for the given training example; and updating the adapter neural network at the training iteration further comprises: generating, for each training example, an input sequence for the training example that includes the pair of content embeddings for the training example; and determining, for each training example, a probability that a user access prediction generated by processing the input sequence for the training example using the sequence processing neural network agrees with the target label for the training example.

Embodiment 4 is the method of claim 3, wherein the user access prediction for each training example characterizes a prediction that a user will access a first digital content item of the pair of digital content items for the training example based on the user having accessed a second digital content item of the pair of digital content items for the training example.

Embodiment 5 is the method of embodiment 4, wherein: the input query for each training example includes data characterizing a particular user for the training example; and the user access prediction for each training example characterizes a prediction that the particular user for the training example will access a first digital content item of the pair of digital content items for the training example based on the particular user for the training example having accessed a second digital content item of the pair of digital content items for the training example.

Embodiment 6 is the method of any one of embodiments 3-5, wherein, at each of the subset of the one or more of training iterations: the target label for each training example for the iteration comprises a target sequence processing neural network output for the training example; determining, for each training example, the probability that the user access prediction generated using the sequence processing neural network by processing the input sequence for the training example agrees with the target label for the training example comprises determining, for each training example, a probability assigned to the target sequence processing neural network output by the sequence processing neural network by processing the input sequence for the training example; and the objective function for the training iteration depends on the probabilities assigned to the target sequence processing neural network outputs for the training iteration by the sequence processing neural network by processing the input sequences for the training examples for the training iteration.

Embodiment 7 is the method of any one of embodiments 2-6, wherein, at one or more of the training iterations, the objective function for the training iteration encourages the adapter neural network to generate (i) more similar pairs of content embeddings for pairs of digital content items that are more likely to both be accessed by a user and (ii) more dissimilar pairs of content embeddings for pairs of digital content items that are less likely to both be accessed by a user.

Embodiment 8 is the method of any one of embodiments 1-7, wherein: the adapter model comprises a content encoder network, one or more cross-attention layers, and a plurality of learned query vectors; and processing the data characterizing the first digital content item using the adapter neural network to generate the content embedding that represents the first digital content item comprises: processing the data characterizing the first digital content item using the content encoder network to generate an encoded representation of the first digital content item; and processing the encoded representation of the first digital content item and the plurality of the learned query vectors using the one or more cross-attention layers to generate the content embedding that represents the first digital content item.

Embodiment 9 is the method of any one of embodiments 1-8, wherein: the input query characterizes a request to describe the digital content item; and the response to the input query includes one or more predicted attributes of the digital content item.

Embodiment 10 is the method of any one of embodiments 1-9, wherein: the input query includes data characterizing a second digital content item and characterizes a request to predict whether a user will access the first digital content item based on the user having accessed the second digital content item; and the response to the input query characterizes a prediction of whether the user will access the first digital content item based on the user having accessed the second digital content item.

Embodiment 11 is the method of embodiment 10, wherein: the input query includes data characterizing a particular user and characterizes a request to predict whether the particular user will access the first digital content item based on the particular user having accessed the second digital content item; and the response to the input query characterizes a prediction of whether the particular user will access the first digital content item based on the particular user having accessed the second digital content item.

Embodiment 12 is a system comprising: one or more computers; and one or more storage devices communicatively coupled to the one or more computers, wherein the one or more storage devices store instructions that, when executed by the one or more computers, cause the one or more computers to perform operations of the respective method of any one of embodiments 1-11.

Embodiment 13 is one or more non-transitory computer storage media storing instructions that when executed by one or more computers cause the one or more computers to perform operations of the respective method of any one of embodiments 1-11.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
receiving an input query that includes data representing a first digital content item;
processing data characterizing the first digital content item using an adapter neural network to generate a content embedding that represents the first digital content item;
generating an input sequence based on the input query that includes the content embedding; and
generating a response to the input query by processing the input sequence using a sequence processing neural network; and
wherein the adapter neural network has been trained to optimize an accuracy of user access predictions generated by the sequence processing neural network for pairs of digital content items.

2. The method of claim 1, wherein training the adapter neural network to optimize an accuracy of user access predictions generated by the sequence processing neural network for pairs of digital content items comprises:
updating the adapter neural network at each of one or more training iterations, comprising:
obtaining training examples for the training iteration, wherein each training example includes data characterizing a pair of digital content items for the training example and includes a target label characterizing user access to both digital content items for the training example;
processing, for each training example, the data characterizing the pair of digital content items to generate a corresponding pair of content embeddings for the training example; and
updating the adapter model using an objective function for the training iteration, wherein the objective function for the training iteration is based on the pairs of content embeddings for the training examples of the training iteration.

3. The method of claim 2, wherein, at each of a subset of the one or more of training iterations:
the objective function for the training iteration measures, based on the target labels for the training examples, an accuracy of user access predictions generated by the sequence processing neural network for the training examples, wherein the user access prediction for a given training example characterizes a prediction that a user will access a first digital content item of the pair of digital content items for the given training example based on the user having accessed a second digital content item of the pair of digital content items for the given training example; and
updating the adapter neural network at the training iteration further comprises:
generating, for each training example, an input sequence for the training example that includes the pair of content embeddings for the training example; and
determining, for each training example, a probability that a user access prediction generated by processing the input sequence for the training example using the sequence processing neural network agrees with the target label for the training example.

4. The method of claim 3, wherein the user access prediction for each training example characterizes a prediction that a user will access a first digital content item of the pair of digital content items for the training example based on the user having accessed a second digital content item of the pair of digital content items for the training example.

5. The method of claim 4, wherein:
the input query for each training example includes data characterizing a particular user for the training example; and
the user access prediction for each training example characterizes a prediction that the particular user for the training example will access a first digital content item of the pair of digital content items for the training example based on the particular user for the training example having accessed a second digital content item of the pair of digital content items for the training example.

6. The method of claim 3, wherein, at each of the subset of the one or more of training iterations:
the target label for each training example for the iteration comprises a target sequence processing neural network output for the training example;
determining, for each training example, the probability that the user access prediction generated using the sequence processing neural network by processing the input sequence for the training example agrees with the target label for the training example comprises:
determining, for each training example, a probability assigned to the target sequence processing neural network output by the sequence processing neural network by processing the input sequence for the training example; and
the objective function for the training iteration depends on the probabilities assigned to the target sequence processing neural network outputs for the training iteration by the sequence processing neural network by processing the input sequences for the training examples for the training iteration.

7. The method of claim 2, wherein, at one or more of the training iterations, the objective function for the training iteration encourages the adapter neural network to generate (i) more similar pairs of content embeddings for pairs of digital content items that are more likely to both be accessed by a user and (ii) more dissimilar pairs of content embeddings for pairs of digital content items that are less likely to both be accessed by a user.

8. The method of claim 1, wherein:
the adapter model comprises a content encoder network, one or more cross-attention layers, and a plurality of learned query vectors; and
processing the data characterizing the first digital content item using the adapter neural network to generate the content embedding that represents the first digital content item comprises:
processing the data characterizing the first digital content item using the content encoder network to generate an encoded representation of the first digital content item; and
processing the encoded representation of the first digital content item and the plurality of the learned query vectors using the one or more cross-attention layers to generate the content embedding that represents the first digital content item.

9. The method of claim 1, wherein:
the input query characterizes a request to describe the digital content item; and
the response to the input query includes one or more predicted attributes of the digital content item.

10. The method of claim 1, wherein:
the input query includes data characterizing a second digital content item and characterizes a request to predict whether a user will access the first digital content item based on the user having accessed the second digital content item; and
the response to the input query characterizes a prediction of whether the user will access the first digital content item based on the user having accessed the second digital content item.

11. The method of claim 10, wherein:
the input query includes data characterizing a particular user and characterizes a request to predict whether the particular user will access the first digital content item based on the particular user having accessed the second digital content item; and
the response to the input query characterizes a prediction of whether the particular user will access the first digital content item based on the particular user having accessed the second digital content item.

12. A system comprising:
one or more computers; and
one or more storage devices communicatively coupled to the one or more computers, wherein the one or more storage devices store instructions that, when executed by the one or more computers, cause the one or more computers to perform operations for selecting actions to be performed by an agent interacting with an environment, the operations comprising:
receiving an input query that includes data representing a first digital content item;
processing data characterizing the first digital content item using an adapter neural network to generate a content embedding that represents the first digital content item;
generating an input sequence based on the input query that includes the content embedding; and
generating a response to the input query by processing the input sequence using a sequence processing neural network; and
wherein the adapter neural network has been trained to optimize an accuracy of user access predictions generated by the sequence processing neural network for pairs of digital content items.

13. One or more non-transitory computer storage media storing instructions that when executed by one or more computers cause the one or more computers to perform operations for selecting actions to be performed by an agent interacting with an environment, the operations comprising:
receiving an input query that includes data representing a first digital content item;
processing data characterizing the first digital content item using an adapter neural network to generate a content embedding that represents the first digital content item;
generating an input sequence based on the input query that includes the content embedding; and
generating a response to the input query by processing the input sequence using a sequence processing neural network; and
wherein the adapter neural network has been trained to optimize an accuracy of user access predictions generated by the sequence processing neural network for pairs of digital content items.

14. The system of claim 12, wherein training the adapter neural network to optimize an accuracy of user access predictions generated by the sequence processing neural network for pairs of digital content items comprises:
updating the adapter neural network at each of one or more training iterations, comprising:
obtaining training examples for the training iteration, wherein each training example includes data characterizing a pair of digital content items for the training example and includes a target label characterizing user access to both digital content items for the training example;
processing, for each training example, the data characterizing the pair of digital content items to generate a corresponding pair of content embeddings for the training example; and
updating the adapter model using an objective function for the training iteration, wherein the objective function for the training iteration is based on the pairs of content embeddings for the training examples of the training iteration.

15. The system of claim 14, wherein, at each of a subset of the one or more of training iterations:
the objective function for the training iteration measures, based on the target labels for the training examples, an accuracy of user access predictions generated by the sequence processing neural network for the training examples, wherein the user access prediction for a given training example characterizes a prediction that a user will access a first digital content item of the pair of digital content items for the given training example based on the user having accessed a second digital content item of the pair of digital content items for the given training example; and
updating the adapter neural network at the training iteration further comprises:
generating, for each training example, an input sequence for the training example that includes the pair of content embeddings for the training example; and
determining, for each training example, a probability that a user access prediction generated by processing the input sequence for the training example using the sequence processing neural network agrees with the target label for the training example.

16. The system of claim 15, wherein the user access prediction for each training example characterizes a prediction that a user will access a first digital content item of the pair of digital content items for the training example based on the user having accessed a second digital content item of the pair of digital content items for the training example.

17. The system of claim 16, wherein:
the input query for each training example includes data characterizing a particular user for the training example; and
the user access prediction for each training example characterizes a prediction that the particular user for the training example will access a first digital content item of the pair of digital content items for the training example based on the particular user for the training example having accessed a second digital content item of the pair of digital content items for the training example.

18. The system of claim 15, wherein, at each of the subset of the one or more of training iterations:
the target label for each training example for the iteration comprises a target sequence processing neural network output for the training example;
determining, for each training example, the probability that the user access prediction generated using the sequence processing neural network by processing the input sequence for the training example agrees with the target label for the training example comprises:
determining, for each training example, a probability assigned to the target sequence processing neural network output by the sequence processing neural network by processing the input sequence for the training example; and
the objective function for the training iteration depends on the probabilities assigned to the target sequence processing neural network outputs for the training iteration by the sequence processing neural network by processing the input sequences for the training examples for the training iteration.

19. The system of claim 14, wherein, at one or more of the training iterations, the objective function for the training iteration encourages the adapter neural network to generate (i) more similar pairs of content embeddings for pairs of digital content items that are more likely to both be accessed by a user and (ii) more dissimilar pairs of content embeddings for pairs of digital content items that are less likely to both be accessed by a user.

20. The system of claim 12, wherein:
the adapter model comprises a content encoder network, one or more cross-attention layers, and a plurality of learned query vectors; and
processing the data characterizing the first digital content item using the adapter neural network to generate the content embedding that represents the first digital content item comprises:
processing the data characterizing the first digital content item using the content encoder network to generate an encoded representation of the first digital content item; and
processing the encoded representation of the first digital content item and the plurality of the learned query vectors using the one or more cross-attention layers to generate the content embedding that represents the first digital content item.
